(19) United States
(12) Patent Application Publication
(10) Pub. No.: US 2009/0096125 A1
(43) Pub. Date: Apr. 16, 2009

(54) Injection molding of thermoplastic polymethylmethacrylate pellets

(76) Inventors: William Patrick Paplham, Getzville, NY (US); William D. Saunders, Delaware City, DE (US); Marc Koester, Buffalo, NY (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/974,285

(22) Filed: Oct. 12, 2007

(51) Int. Cl. B29C 59/00

(52) U.S. Cl. 264/122

(57) ABSTRACT

Injection molding of thermoplastic polymethylmethacrylate pellets and decorative crosslinked polymethylmethacrylate particles employs an injection nozzle which has a size smaller than at least a portion of the polymethacrylate particles.

### BACKGROUND OF THE INVENTION

1. Field of the Invention

This invention relates to injection molding of thermoplastic polymethylmethacrylate pellets and decorative crosslinked polymethylmethacrylate particles.

2. Description of the Related Art

Articles formed by injection molding polymeric compositions serve both functional and decorative purposes. Since their use is enhanced by incorporating various attractive and/or unique decorative patterns, such patterns provide visual effects which differentiate one product from another. The same principle applies to naturally occurring materials such as wood or stone whose use, for example in furniture construction, is enhanced by certain natural aesthetics, e.g., grain, color variations, veins, and others. Commercially manufactured solid surface materials, such as Corian® from E. I. DuPont de Nemours, often incorporate particles intended to imitate or resemble the naturally occurring patterns in granite or marble. These particles are generally made from polymeric material which is ground into decorative particles, known to the industry as “crunchies”. Attempts to employ injection molding with a combination of thermoplastic polymer pellets and crosslinked polymer particles have introduced problems, particularly if the crosslinked particles are larger that a diameter of a nozzle of an injection molding machine.

There is a need for an injection molding process which employs thermoplastic polymer pellets as well as crosslinked polymer particles which are larger than an injection molding machine nozzle.

### SUMMARY OF THE INVENTION

The present invention is directed to a process for injection molding thermoplastic polymethylmethacrylate pellets and crosslinked polymethylmethacrylate particles comprising the steps of:
(a) forming a blend of:
   (i) thermoplastic polymethylmethacrylate pellets,
   (ii) crosslinked polymethylmethacrylate particles which can be softened by heat,
   (iii) acrylate monomer and
   (iv) polymerization initiator for the acrylate monomer
(b) introducing the blend into an injection molding machine,
(c) employing a temperature of at least 190 degrees centigrade in the injection molding machine,
(d) maintaining the blend in the heated injection molding machine for a period of time of at least 1 minute,
(e) injecting the heated blend into a mold through a nozzle with a nozzle width smaller than at least a portion of the largest diameter of the crosslinked polymethylmethacrylate particles,
(f) cooling the blend to obtain a solidified article,
   with a proviso that at least a portion of crosslinked polymethylmethacrylate particles in the solidified article maintain a particle size greater than the nozzle width.

### DETAILED DESCRIPTION OF THE PREFERRED EMBODIMENTS

A first material for injection molding are pellets formed from thermoplastic polymethylmethacrylate polymer which soften at a temperature of 190 degrees centigrade. The size of the pellets is not critical and can vary dependent on the size of an employed injection molding machine. The only requirement is for polymer fragments to be inserted into an injection molding machine (which insertion typically is by gravity or by some type of conveyor). For purposes of illustration a pellet size will be in a range from 0.3175 to 2.54 centimeters centimeters, and more generally within a range from 0.3175 to 0.635 centimeters centimeters. It is understood that the size of pellets employed in a molding process will vary and both smaller and larger pellet sizes can be employed.

A second material for injection molding are crosslinked polymethylmethacrylate particles which introduce a decorative appearance to a final article. It is understood that the particles are only partially crosslinked which means the particles will soften at a temperature at a temperature of 190 degrees centigrade. A conventional range for particle size is from 0.04 to 10.3 mm in greatest average dimension, and more generally within a range from 1.524 to 4.826 mm. As will be more fully explained below at least a portion of the particles will be larger than a width of a nozzle of an injection molding machine.

A third material for injection molding is an acrylate monomer. Suitable monomers include, but are not limited to, methyl acrylate, ethyl acrylate, i-propyl acrylate, n-propyl acrylate, n-butyl acrylate, i-butyl acrylate, and lauryl acrylate. Fatty acid esters such as stearyl acrylate may be used. A preferred polymerizable monomer is 2-ethylhexylacrylate.

A fourth material for injection molding is a polymerization initiator to cause polymerization of the acrylate monomer. Generally a polymerization initiator also will be employed within the pellets to allow crosslinking of the thermoplastic polymethylmethacrylate. The same polymerization initiator can be used for both the thermoplastic polymerization pellets and acrylate monomer. However it is within the scope of the present invention that different polymerization initiators are employed which optimize crosslinking of the pellets and polymerization of the monomer. A preferred initiator is a peroxide such as Lupersol® 101, 2,5-dimethyl-2-5-di(t-butylperoxy)hexane sold by Elf Atochem, Inc.

The present four required materials of the present invention overcome problems have been introduced in the prior art with attempts to injection mold a combination of thermoplastic and crosslinked methylmethacrylate polymers. A typical concern is with the use of crosslinked particles which are larger than the width of a gate of an injection mold. Gate is used in its usual meaning in the field of injection molding to mean an orifice through which an injection molding compostion enters into a mold cavity. Typically the gate extends into the mold allowing a molding composition to enter the mold with turbulence resulting in a complete filing of the mold.

In some instances, the molding composition contains solid particles which are larger than the gate width resulting in a change of dimension. Such change of dimension is minimized or avoided in the present invention. An important use of the particles in the molding composition is to impart a specific appearance in the final injected molded article and to maintain particle integrity directed to size and shape. A prior art solution is to employ a larger gate but in many instances the use of a larger gate becomes impractical. Accordingly the present invention overcomes the need for a larger gate.

As employed herein “width” means the smallest dimension in an injection molding gate allowing a composition to be injected in a mold.

Without being bound to any theory, it is considered the acrylic monomer acts as a lubricant for the crosslinked polymethylmethacrylate particles. Since the particles are softened by heat in the injection molding process, the monomer is considered to allow the particles to pass more easily with reduced friction through the gate which has a size smaller than the particles. For purposes of illustration at least 30 percent by weight and more generally in many applications at least 50 percent and more preferably 80 percent of the particles will have a size larger than the width of the injection molding nozzle.

Also a critical aspect of the present invention is a requirement that the materials employed herein be maintained for a time period of at least one minute within the heated injection molding machine. Longer time periods are suitable but with reduced throughput in the number of articles which can be made.

The amounts of materials added above will vary. Conventionally only a small amount of polymerization initiator is employed. However for purposes of illustration the following ranges will be employed expressed as parts by weight: the first material of pellets in a range of 60 to 95 parts, the second material of particles in a range of about 0 to 20 parts, the third material of acrylate monomer of 1 to 5 parts and the fourth material of initiator of 0.01 to 0.12 parts. A more preferred range of the first, second, third and fourth materials is 75 to 85, 1 to 15, 2 to 4 and 0.04 to 0.08 respectively.

It is understood that additional materials may be added to the four required materials set forth above. Illustratively it is conventional to add a fire retardant such as hydrated alumina, hydrated calcium sulfate, zinc borate, and mixtures thereof. A preferred fire retardant material is aluminum trihydroxide. However with use of this fire retardant, it is preferred to maintain the operating temperature of the injection molding machine not higher than 210 degrees centigrade, i.e. a temperature in a range from 190 to 210 degrees centigrade. An example of the amount of fire retardant additive, including aluminum trihydroxide, is in a range from 40 to 60 weight percent of the final article.

In addition to materials noted above, additives such as pigments, dyes, rubbers, antioxidants and the like as known to those skilled in the art may be added.

The process of the invention employs an injection molding machine of the general type used in the industry. A hopper is provided for introducing thermoplastic methylmethacrylate, in the form of pellets, and decorative partially crosslinked methylmethacrylate particles into the machine. The injection molding machine has a barrel with a centrally extending bore with a screw disposed within the bore. A heating system, consisting of a series of heating elements and thermocouples surrounds the barrel. A feed throat is provided to allow direct introduction of additional materials, i.e. additives, to the barrel. The moldable composition is conveyed by the screw toward a nozzle at the downstream end of the barrel, there to be injected into a mold having a gate and cavity. The thermocouples provide temperature information to a control system which powers heating elements. Heat is also generated due to shear by the screw conveying the pellets between the screw and barrel. These heat sources melt the thermoplastic polymer and softens the partially crosslinked particles.

In the process of the present invention the heating temperature is kept no higher than 210 C with a preferred additive of aluminum trihydroxide to minimize decomposition. However higher temperatures such as up to 230 degrees centigrade can be employed with additives which do not decompose or degrade within this range. Also an operating temperature above a minimum of 190 degrees centigrade may be preferred to allow additional flow of the thermoplastic polymethylmethacrylate polymer. This polymer typically has a high viscosity at the temperatures employed in injection molding so necessary torque to turn a feedscrew exceeds the capability of a typical injection molding machine which in turn causes injection pressures to rise to unsatisfactory high levels. In the present process this problem is overcome by use of the composition as described above.

It has been found that for the decorative thermoset particles to transit the injection molding machine without being comminuted into smaller particles (which will degrade their aesthetic appeal) they must first be heated for a time period of not less than one minute and more preferably two minutes.

In an optional mode, the mold is independently heated prior to the flow from the injection machine nozzle. For purposes of illustration a mold temperature of at least 90 degrees centigrade is suitable with an uppermost temperature of 100 degrees centigrade. Thereafter the injected molded part is cooled.

The following examples, in which parts and percentages are by weight unless otherwise indicated, further illustrate the invention.

### Example

The following composition was pelletised:
50% aluminum trihydroxide filler
47% thermoplastic polymethylmethacrylate polymer
3% 2-ethylhexylacrylate monomer/peroxide in a ratio of 98:2.

The pellets were combined with 15% by weight of partially crosslinked polymethylmethacrylate particles sieved to a particle size of 4-12 mesh (between 0.06-0.19″) to form a blend. The blend was coated 1.5% by weight with a 99:1 mixture of 2-ethylhexylacrylate peroxide by pouring onto the pellets and mixing.

After mixing, the coated blend was poured into a molding machine hopper. The molding machine screw had a clearance of 0.102 inches in a metering section, and 0.274 inches in a feed section. The machine barrel was heated to 190 C. (374 F) and a residence time of 2 minutes took place while the coated blend was in a barrel of the molding machine. A screw was turned at 42 rpm to melt the blend and feed the molten blend down the screw.

A receiving mold was a block of steel with a cavity to allow the shape of a final desired article with the block surrounded by channels for heating or cooling by use of hot or cold water flowing through the channels. A first water circulating unit (thermolator) set for heating to 90 C was used to heat the mold prior to injection of the molten blend.

The molding machine barrel was purged by running 15 injection molding shots which were thrown away. The molten blend was injected into the mold, which was in the shape of a handle for a jigsaw powertool. A second thermolator was set to 60 C and used to cool the mold employing chilled water. There was no time delay between the heating and cooling of the mold. The gate dimensions were 0.062×0.125 inches. The total time to complete a cycle of heating the mold, injecting the molten blend, and cooling the mold was 85 seconds.

A visual observation indicated the crosslinked polymethylmethacrylate particles maintained their initial size and shape even though they passed through channels that were dimensionally smaller than their largest dimension. The particles were distributed evenly throughout the final article and were visible on its surface.

What is claimed is:

1. A process for injection molding thermoplastic polymethylmethacrylate pellets and crosslinked polymethylmethacrylate particles comprising the steps of:
(a) forming a blend of:
(i) thermoplastic polymethylmethacrylate pellets,
(ii) crosslinked polymethylmethacrylate particles which can be softened by heat,
(iii) acrylate monomer and
(iv) polymerization initiator for the acrylate monomer,
(b) introducing the blend into an injection molding machine,
(c) employing a temperature of at least 190 degrees centigrade in the injection molding machine,
(d) maintaining the blend in the heated injection molding machine for a period of time of at least 1 minute,
(e) injecting the heated blend into a mold through a gate with a width smaller than at least a portion of the largest diameter of the crosslinked polymethylmethacrylate particles,
(f) cooling the blend to obtain a solidified article,
with a proviso that at least a portion of crosslinked polymethylmethacrylate particles in the solidified article maintain a particle size greater than the gate width.

2. The process of claim 1 wherein the pellets have a size in a range from 0.3175 to 2.54 centimeters.

3. The process of claim 2 wherein the pellets have a size in a range from 0.3175 to 0.635 centimeters.

4. The process of claim 1 wherein the polymethylmethacrylate particles have a size in a range from 0.04 to 10.3 millimeters.

5. The process of claim 4 wherein the polymethylmethacrylate particles have a size in a range from 1.524 to 4.826 millimeters.

6. The process of claim 1 wherein the acrylate monomer is 2-ethylhexylacrylate.

7. The process of claim 1 wherein the polymerization initiator is a peroxide.

8. The process of claim 1 wherein the thermoplastic pellets have a size in a range from 0.3175 to 2.54 centimeters, the polymethylmethacrylate particles have a size in a range from 0.04 to 10.3 millimeters, the acrylate monomer is 2-ethylhexylacrylate and the polymerization initiator is a peroxide.
